(19) United States
(12) Patent Application Publication
(10) Pub. No.: US 2011/0090000 A1
(43) Pub. Date: Apr. 21, 2011

(54) SIGNAL TRANSMISSION CIRCUIT

(75) Inventors: Satoshi TOMINAGA, Tokyo (JP); Yoshinori MATSUI, Tokyo (JP)

(73) Assignee: ELPIDA MEMORY, INC., Tokyo (JP)

(21) Appl. No.: 12/908,563

(22) Filed: Oct. 20, 2010

(30) Foreign Application Priority Data
Oct. 21, 2009 (JP) 2009-242402

(51) Int. Cl. G05F 3/02

(52) U.S. Cl. 327/540

(57) ABSTRACT

To provide an inverter including first and second transistors connected in series between first and second power supply lines, a source transistor that is provided between the first power supply line and the first transistor and is conductive based on a control signal, and a load transistor that serves as a load circuit provided between the second power supply line and the second transistor. According to the present invention, because a difference between a load between the first power supply line and the first transistor and a load between the second power supply line and the second transistor is reduced, a difference between a signal propagation rate at which an input signal supplied to the inverter changes from a low level to a high level and a signal propagation rate at which the input signal changes from the high level to the low level is reduced.

### BACKGROUND OF THE INVENTION

1. Field of the Invention

The present invention relates to a signal transmission circuit, and more particularly relates to a signal transmission circuit in which a logical level of a signal is fixed in a standby state.

2. Description of Related Art

In recent years, an operating voltage of a semiconductor device is gradually reduced with a view to reducing power consumption and currently a voltage as low as about 1 volt is sometimes used as an operating voltage. When the operating voltage falls, it is necessary to reduce threshold voltages of transistors accordingly. This disadvantageously causes an increase in a sub-threshold current of a transistor that is non-conductive. To solve this problem, there is proposed a method of dividing a bower supply line into a main bower supply line and a pseudo-power supply line as disclosed in FIG. 4 of Japanese Patent Application Laid-Open No. H11-31385.

FIG. 4 of the Japanese Patent Application Laid-Open No. H11-31385 discloses a circuit in which four inverters V1 to V4 are cascade-connected. Four power supply lines supply operating voltages to the inverters V1 to V4. The four Power supply lines are: a main power supply line VCC and a pseudo-power supply line VCT which are supplied with a power supply potential; and a main power supply line VSS and a pseudo-power supply line VST which are supplied with a ground potential. A P-channel source transistor P1 is provided between the main power supply line VCC and the pseudo-power supply line VCT, and a signal SCPB is supplied to a gate electrode of the source transistor P1. An N-channel source transistor N1 is provided between the main power supply line VSS and the pseudo-power supply line VST, and a signal SON is supplied to a gate electrode of the source transistor N1.

When the signal transmission circuit is active (in an active state), the source transistors P1 and N1 are turned on. As a result, the main power supply line VCC is short-circuited to the pseudo-power supply line VCT via the source transistor P1. In addition, the main power supply line VSS is short-circuited to the pseudo-power supply line VST via the source transistor N1. On the other hand, when the signal transmission circuit is in a standby state, the source transistors P1 and N1 are both turned off. The pseudo-power supply lines VST and VCT are thereby disconnected from the main power supply lines VSS and VCC, respectively, and power supply potentials are hardly supplied to the pseudo-power supply lines VST and VCT.

Among the four inverters V1 to V4, the first inverter V1 and the third inverter V3 are connected in between the pseudo-power supply line VCT and the main power supply line VSS. The second inverter V2 and the fourth inverter V4 are connected in between the main power supply line VCC and the pseudo-power supply line VST. As described above, in the active state, the main power supply line VCC is short-circuited to the pseudo-power supply Line VCT and the main power supply line VSS is also short-circuited to the pseudo-power supply line VCC. Therefore, the power supply voltages are correctly applied to both power supply nodes of each of the inverters V1 to V4.

On the other hand, in the standby state, the pseudo-power supply line VCT is disconnected from the main power supply line VCC and the pseudo-power supply line VST is disconnected from the main power supply line VSS. Therefore, the power supply potentials are hardly supplied to sources of P-channel MOS transistors P2 and P4 included in the first inverter V1 and the third inverter V3, respectively. Similarly, the power supply potentials are hardly supplied to sources of N-channel MOS transistors N3 and N5 included in the second inverter V2 and the fourth inverter V4, respectively.

However, the above circuit is configured to fix an input signal ROB to a high level in the standby state. Therefore, transistors N2, P3, N4, and P5 are conductive in the respective inverters V1 to V4. Because sources of these transistors N2, P3, N4, and P5 are connected to the main power supply line VCC or VSS, is possible to correctly maintain a logical level of the signal in the standby state. On the other hand, the sources of the transistors P2, N3, P4, and N5 that are non-conductive in the standby state are connected to the pseudo-power supply line VCT or VST disconnected from the main power supply line VCC or VSS, respectively. Therefore, a sub-threshold current hardly flows in the transistors P2, N3, P4, and N5. With this configuration, it is possible to reduce power consumption in the standby state.

However, the conventional technique has the following problems. That is, in the signal transmission circuit shown in FIG. 4 of Japanese Patent Application Laid-Open No. H11-31385, a signal propagation rate at which the input signal ROB changes from a low level to a high level disadvantageously differs from a signal propagation rate at which the input signal ROB changes from the high level to the low level. This problem is caused by the presence of the source transistors P1 and N1. That is, when the input signal ROB changes from the low level to the high level, because the sources of the transistors (N2, P3, N4, and P5) that are turned on are directly connected to the main power supply line VCC or VSS, power is supplied to the transistors N2, P3, N4, and P5 without having any influence from the source transistors P1 and N1.

On the other hand, when the input signal ROB changes from the high level to the low level, because the transistors (P2, N3, P4, and P5) that are turned on are connected to the pseudo-power supply line VCT or VST, the power is supplied to the transistors P2, N3, P4, and P5 via the source transistors P1 and N1.

As a result, the signal propagation rate at which the input signal ROB changes from the high level to the low level is slightly lower than the signal propagation rate at which the input signal ROB changes from the low level to the high level. Such a propagation rate difference is greater along with recent developments of voltage-reduction techniques and disadvantageously causes a reduction in a margin for timing control. That is, most of semiconductor devices perform signal fetching and the like using a timing clock such as a strobe signal. Accordingly, when a delay amount differs according to a signal transition direction, a margin for data fetching or the like using the timing signals decreases.

For example, even when the delay amount of the signal transmission circuit is adjusted to be able to fetch data changing from the low level to the high level at the same timing as that of the timing clock in the above example, a problem occurs that setup time runs short. This is because the delay amount of the data changing from the high level to the low level is large than that of the data changing from the low level to the high level.

### SUMMARY

In one embodiment, there is provided a signal transmission circuit that includes: a first logical circuit including a first transistor of a first conductive type and a second transistor of a second conductive type, the first and second transistors being connected in series between first and second power supply lines; a first source transistor of the first conductive type provided between the first power supply line and the first transistor, the first source transistor being conductive based on a first control signal; and a first load circuit provided between the second power supply line and the second transistor.

According to the present invention, the first load circuit is connected in between the second power supply line and the second transistor. Therefore, it is possible to reduce a difference between a load between the first power supply line and the first transistor and that between the second power supply line and the second transistor. This can reduce a difference between a signal propagation rate at which an input signal supplied to the logical circuit changes from a low level to a high level and a signal propagation rate at which the input signal changes from the high level to the low level. Accordingly, it is possible to secure a sufficient margin for timing control.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a circuit diagram of a signal transmission circuit 2 according to an embodiment of the present invention;

FIGS. 2A and 2B are circuit diagrams of the inverters, where FIG. 2A is a circuit diagram of the odd-numbered inverters 11, 13, . . . and FIG. 2B is a circuit diagram of the even-numbered inverters 12, 14, . . . ;

FIGS. 3A and 3B are circuit diagrams of the inverters according to a modified example, where FIG. 3A is a circuit diagram of the odd-numbered inverters 11, 13, . . . and FIG. 3B is a circuit diagram of the even-numbered inverters 12, 14, . . . ;

FIG. 4 is a circuit diagram of a signal transmission circuit 4 according to a modified example.

FIG. 5 is a block diagram showing a circuit configuration of a data input unit of a semiconductor memory using the signal transmission circuit 2;

FIG. 6 is a timing chart for explaining an operation performed by the data input unit; and

FIG. 7 is a circuit diagram of a latch circuit 80-1.

### DETAILED DESCRIPTION OF THE EMBODIMENTS

Preferred embodiments of the present invention will be explained below in detail with reference to the accompanying drawings.

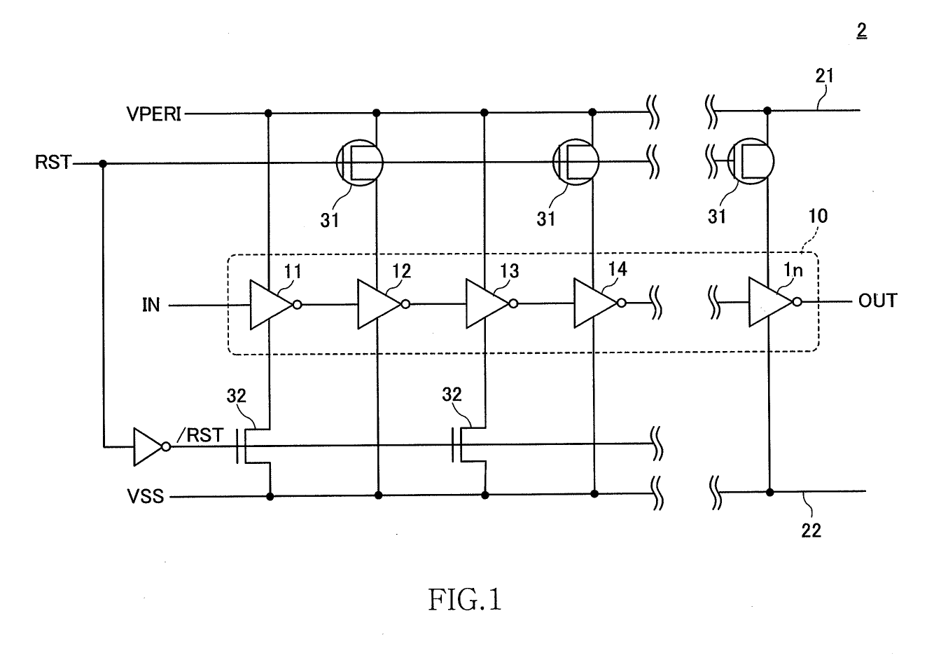

FIG. 1 is a circuit diagram of a signal transmission circuit 2 according to an embodiment of the present invention.

The signal transmission circuit 2 shown in FIG. 1 includes a transmission path 10 on which n inverters 11 to 1n are cascade-connected, where n is a natural number, and a pair of power supply lines 21 and 22 supplying operating voltages to the transmission path 10. The transmission oath 10 is a circuit that delays an input signal IN using the n inverters 11 to 1n and that outputs the delayed signal IN as an output signal OUT. The input signal IN is a signal a logical level of which changes when the signal transmission circuit 2 is active (in an active state) and the logical level of which is fixed to a low level when the signal transmission circuit 2 is in a standby state. Furthermore, the power supply line 21 is a wiring that is supplied with a high-potential-side power supply potential VPERI, and the power supply line 22 is a wiring that is supplied with a low-potential-side power supply potential VSS.

As shown in FIG. 1, high-potential-side power supply nodes of odd-numbered inverters 11, 13, . . . are directly connected to the power supply line 21 and low-potential-side nodes thereof are connected to the power supply line 22 via source transistors 32, respectively. Conversely, low-potential-side power supply nodes of even-numbered inverters 12, 14, . . . are directly connected to the power supply line 22 and high-potential-side thereof are connected to the power supply line 21 via source transistors 31, respectively. A reset signal RST is supplied to a gate of each of the source transistors 31 and an inverted reset signal /RST is supplied to a gate of each of the source transistors 32. The reset signal RST is a signal that is at a low level in the active state and that is at a high level in the standby state. Therefore, in the active state (the reset signal RST=L), the operating potentials are supplied to both power supply nodes of each of the inverters 11 to 1n. In the standby state (the reset signal RST=H), the operating potentials are supplied only to one of the power supply nodes of each of the inverters 11 to 1n.

However, in the standby state, the input signal IN is fixed to the low level as described above. Therefore, outputs from the odd-numbered inverters 11, 13, . . . are at a high level and those from the even-numbered inverters 12, 14, . . . are at a low level. As for the odd-numbered inverters 11, 13, . . . that are supposed to output the high level, the high-potential-side power supply nodes thereof are directly connected to the power supply line 21. As for the even-numbered inverters 12, 14, . . . that are supposed to output the low level, the low-potential-side power supply nodes thereof are directly connected to the power supply line 22. Therefore, the logical level of the input signal IN is kept correctly in the standby state. Further, the low-potential-side power supply nodes of the odd-numbered inverters 11, 13, . . . and the high-potential-side power supply nodes of the even-numbered inverters 12, 14, . . . are disconnected from the power supply lines 21 and 22 by the source transistors 31 and 32, respectively. With this configuration, a sub-threshold current hardly flows in the inverters 11 to 1n. This can reduce power consumption in the standby state.

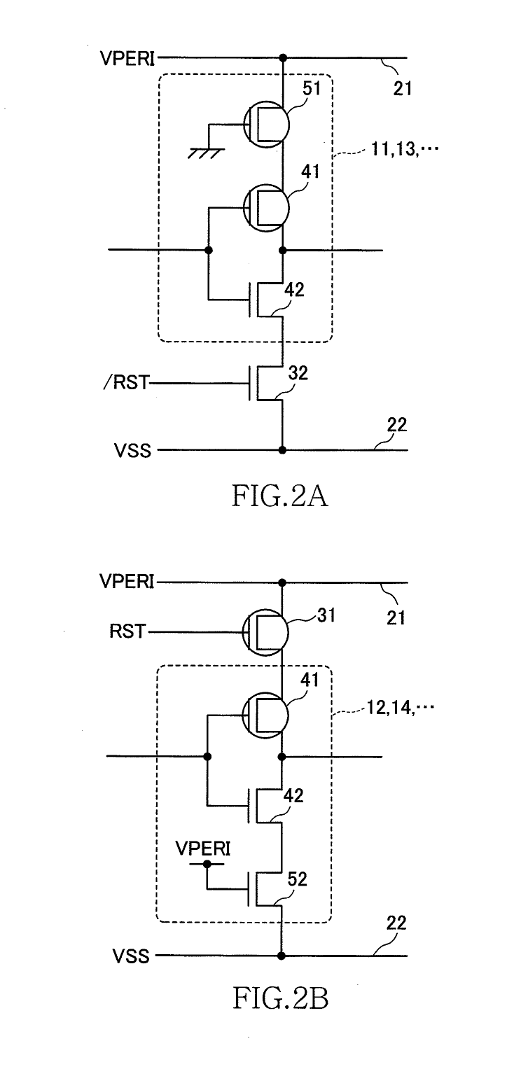

FIGS. 2A and 2B are circuit diagrams of the inverters, where FIG. 2A is a circuit diagram of the odd-numbered inverters 11, 13, . . . and FIG. 2B is a circuit diagram of the even-numbered inverters 12, 14, . . .

As shown in FIG. 2A, each of the odd-numbered inverters 11, 13, . . . is configured to include a P-channel MOS transistor 41 and an N-channel MOS transistor 42 connected in series, and a load transistor 51 that is a load circuit connected in between the power supply line 21 and the transistor 41. Gates of the transistors 41 and 42 are connected in common and supplied with an output from the inverter in front of each of the inverter 11, 13, . . . (hereinafter, simply “front inverter”). Drains of the transistors 41 and 42 are also connected in common and supply outputs to the inverter in rear of each of the inverter 11, 13, . . . (hereinafter, simply “rear inverter”). A source of the transistor 41 is connected to the power supply line 21 via the load transistor 51, and a source of the transistor 42 is connected to the power supply line 22 via the source transistor 32. The load transistor 51 is a P-channel MOS transistor and a gate of the load transistor 51 is fixed to a power supply potential VSS. Accordingly, the load transistor 51 is always on.

Meanwhile, as shown in FIG. 2B, each of the even-numbered inverters 12, 14, . . . is configured to include the P-channel MOS transistor 41 and the N-channel MOS transistor 42 connected in series, and a load transistor 52 that is a load circuit connected in between the power supply line 22 and the transistor 42. The transistors 41 and 42 are identical to those in an ordinary inverter and also identical to those described above with reference to FIG. 2A. The source of the transistor 41 is connected to the power supply line 21 via the source transistor 31, and the source of the transistor 42 is connected to the power supply line 22 via the load transistor 52. The load transistor 52 is an N-channel MOS transistor and a gate of the load transistor 52 is fixed to a power supply potential VPERI. Accordingly, the load transistor 52 is always on.

With this configuration, when the input signal IN shown in FIG. 1 changes from the low level to the high level in the active state (the reset signal RST=L), the transistors 42 included in the odd-numbered inverters 11, 13, . . . are turned on, and the transistors 41 included in the even-numbered inverters 12, 14, . . . are turned on. In this case, a load component of the source transistor 31 or 32 is superimposed on a delay amount of each inverter, because the source transistor 31 or 32 always interposes between the transistor that is turned on and the power supply line 21 or 22.

On the other hand, when the input signal IN changes from the high level to the low level in the active state (the reset signal RST=L), the transistors 41 included in the odd-numbered inverters 11, 13, . . . are turned on, and the transistors 42 included in the even-numbered inverters 12, 14, . . . are turned on. In this case, a load component of the load transistor 51 or 52 is superimposed on a delay amount of each inverter, because the load transistor 51 or 52 always interposes between the transistor that is turned on and the power supply line 21 or 22.

With this configuration, as compared with a case where no load transistors 51 and 52 are provided, a difference between a signal propagation rate at which the input signal IN changes from the low level to the high level and that at which the input signal IN changes from the high level to the low level is reduced. Particularly, when loads of the load transistors 51 and 52 are made to coincide with those of the transistors 31 and 32, the difference between these signal propagation rates is substantially zero. Therefore, it is possible to make the signal propagation rates constant irrespectively of a transition direction of the input signal IN.

Specifically, it is preferable to make the load of the load transistor 51 coincide with that of the source transistor 32 included in the corresponding inverter, and to make the load of the load transistor 52 coincide with that of the source transistor 31 included in the corresponding transistor. This can make a transition rate from the high level to the low level coincide with that from the low level to the high level for every inverter.

Further, it is more preferable to make the load of the load transistor 51 coincide with that of the source transistor 31 included in the front or rear inverter and to make the load of the load transistor 52 coincide with that of the source transistor 32 included in the front or rear inverter. This can make a transition rate from the high level to the low level coincide with that from the low level to the high level between the adjacent inverters. To realize this, it suffices to make characteristics of the load transistor 51 coincide with those of the source transistor 31 by designing the load transistor 51 and the source transistor 31 to have the same gate length, the same gate width, the same gate thickness and the like. In addition, it suffices to make characteristics of the load transistor 52 coincide with those of the source transistor 32 by designing the load transistor 52 and the source transistor 32 to have the same gate length, the same gate width, the same gate thickness and the like. This can make the loads of the transistors 51 and 31 or 52 and 32 coincide with each other even when a process irregularity (a P variation), a voltage variation (a V variation), a temperature change (a T variation) or the like occurs.

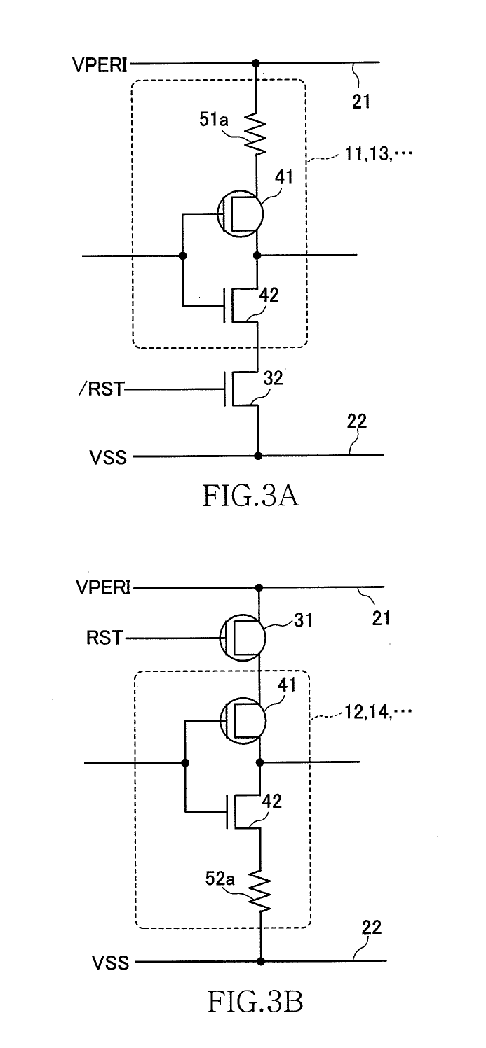

In the above embodiment, the load transistors 51 and 52 are used as load circuits; however, the present invention is not limited thereto, and other elements such as resistances or capacitances can be used in stead of the load transistors 51 and 52, or load circuits each constituted by a combination of a resistance and a capacitance can be used in stead of the load transistors 51 and 52. FIGS. 3A and 3B show an example of using resistances 51a and 52a in stead of the load transistors 51 and 52, respectively.

Furthermore, it is preferable to adopt transistors each having a relatively low threshold as the transistors 41 and 42 included in each inverter to realize high-rate switching, and to adopt transistors each having a relatively high threshold as the source transistors 31 and 32 to reduce sub-threshold leakage in the standby state. In this case, it is also preferable to use transistors each having a high threshold as the load transistors 51 and 52 according to the source transistors 31 and 32.

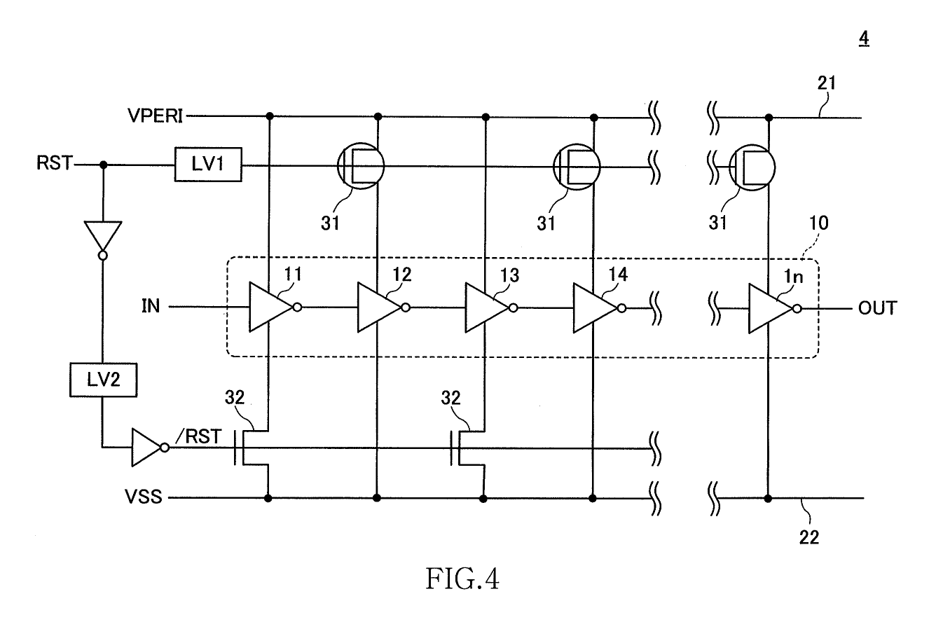

Moreover, even when the transistors each having the high threshold are not used as the source transistors 31 and 32, the sub-threshold leakage can be reduced in the standby state by setting an absolute value of a potential level of the reset signal RST high and that of a potential level of the reset signal /RST low. This can be realized by converting the levels of the reset signals RST and /RST using level shifters LV1 and LV2, respectively, as shown in a signal transmission circuit 4 shown in FIG. 4. For example, when amplitude of the rest signal RST is VPERI-VSS before level conversion, it suffices to increase the amplitude of the reset signal RST to VPP (>VPERI)-VSS using the level shifter LV1, and to increase that of the reset signal /RST to VPERI-VKK (<VSS) using the level shifter LV2. Alternatively, both of the reset signals RST and /RST can be set to have the amplitude of VPP-VKK. When the transistors each having the low threshold are used as the source transistors 31 and 32 as described above, it is possible to similarly use transistors each having a low threshold as the load transistors 51 and 52. Moreover, in this case, an N-channel transistor and a P-channel transistor can be used as the source transistors 31 and 32, respectively.

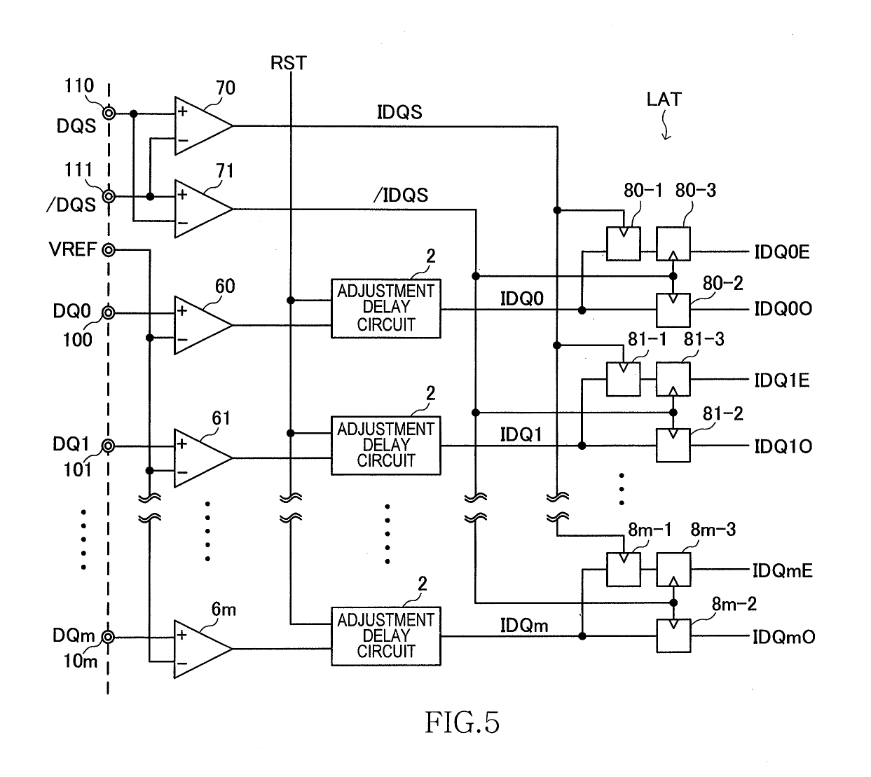

FIG. 5 is a block diagram showing a circuit configuration of a data input unit of a semiconductor memory. In the example shown in FIG. 5, the signal transmission circuit 2 is used as “adjustment delay circuit” that delays write data DQ.

The data input unit shown in FIG. 5 is a circuit for fetching write data DQ0 to DQm supplied from outside to data terminals 100 to 10m, where m is a natural number, respectively, in a latch circuit block LAT synchronously with strobe signals DOS and /DQS serving as timing signals. The strobe signals DOS and /DQS are supplied to strobe terminals 110 and 111, respectively. The write data DQ0 to DQm is supplied to “adjustment delay circuits” constituted by the signal transmission circuits 2 via corresponding input receivers 60 to 6m, respectively. The adjustment delay circuits are used to adjust phases of internal write data IDQ0 to IDQm so that a center of a so-called data window of each of the serial write data DQ0 to DQm coincide with active edges of the strobe signals DQS and /DQS output from the input receiver 70 and 71, respectively.

The write data DQ0 to DQm is either at a high level or a low level, and therefore when the signal transmission circuit 2 according to the present embodiment is used as each of the adjustment delay circuits, it is possible to rake propagation rates of signals constant in the active state while reducing power consumption in the standby state. Further, the adjustment delay circuits are provided to correspond to the respective pieces of write data DQ0 to DQm and can adjust the write data DQ0 to DQm in a different manner from one another.

The internal write data IDQ0 to IDQm passed through the respective adjustment delay circuits is fetched in corresponding latch circuits included in the latch circuit block LAT synchronously with internal strobe signals IDQS and /IDQS.

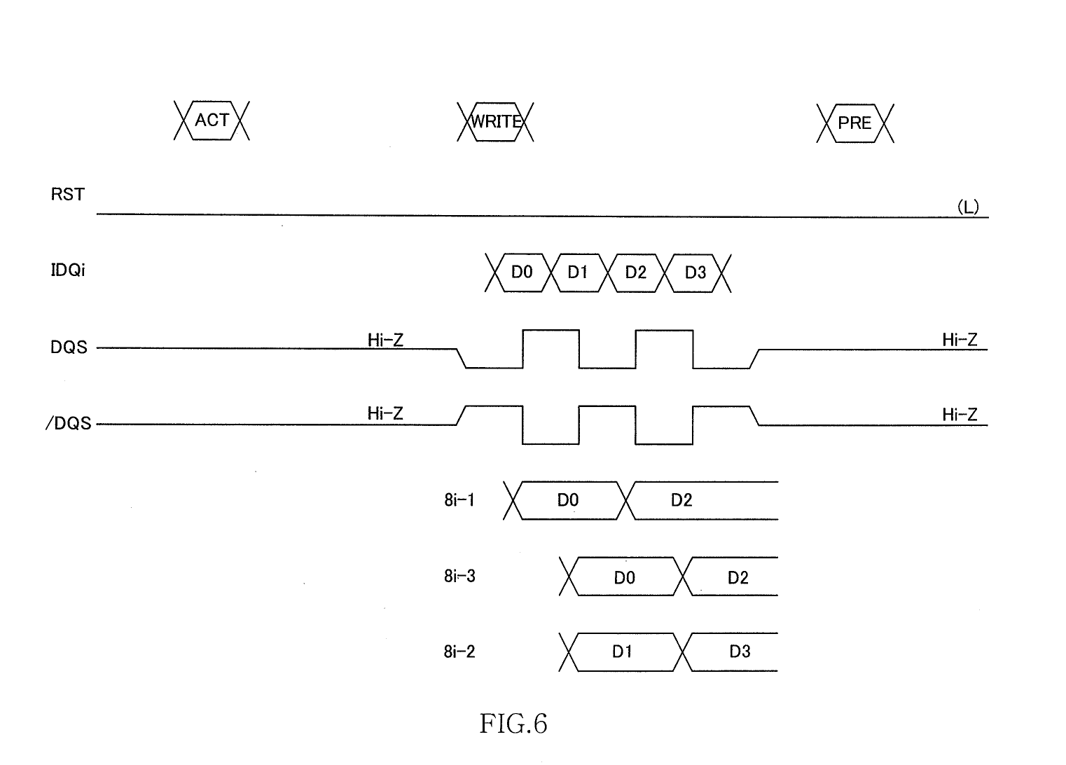

FIG. 6 is a timing chart for explaining an operation performed by the data input unit shown in FIG. 5.

In an example shown in FIG. 6, after an active command ACT and a write command WRITE are issued in this order, four bits of write data DQi (i=0 to m) are input in series. In FIG. 6, the four bits of write data DQi are denoted by D0 to D3, respectively.

Initially, the first write data DO is latched in a latch circuit 8i-1 synchronously with a rising edge of the strobe signal DQS. The write data DO fetched in the latch circuit 8i-1 is then fetched in a latch circuit 8i-3 synchronously with a rising edge of the subsequent strobe signal /DQS. At the same time as that when the write data D0 is fetched in the latch circuit 8i-3, the second write data D1 is fetched in a latch circuit 8i-2. The write data D1 and D0 fetched in the latch circuit 8i-2 and 8i-3 is transmitted to and held by other data latch circuits (not shown), respectively.

Next, the third write data D2 is fetched in the latch circuit 8i-1 synchronously with the rising edge of the subsequent strobe signal DQS. Similarly, the third write data D2 and the fourth write data D3 are fetched in the latch circuit 8i-3 and 8i-2, respectively.

The adjustment delay circuits constituted by the signal transmission circuits 2 are used in the data input unit performing such an operation. Therefore, as described above, it is possible to make the propagation rates of signals constant in the active state while reducing the power consumption in the standby state.

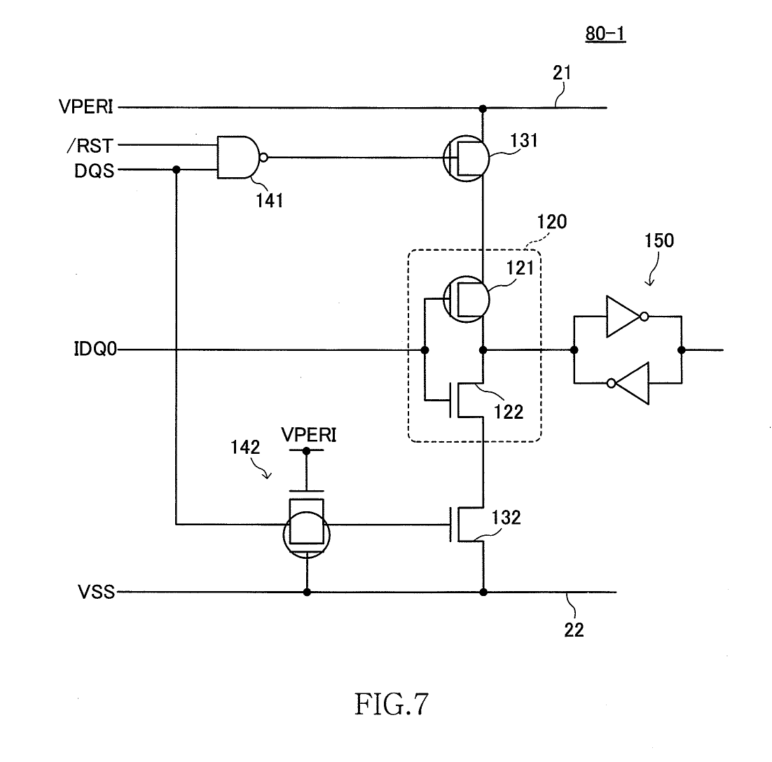

FIG. 7 is a circuit diagram of a latch circuit 80-1.

As shown in FIG. 7, the latch circuit 80-1 includes an inverter 120 that receives the internal write data IDQ0 and a flip-flop circuit 150 that holds an output from the inverter 120. The inverter 120 is configured to include a P-channel MOS transistor 121 and an N-channel MOS transistor 122 connected in series. A source of the transistor 121 is connected to the power supply line 21 via a source transistor 131, and a source of the transistor 122 is connected to the power supply line 22 via a load transistor 132. An output from a NAND circuit 141 that receives the reset signal /RST and the strobe signal DQS is supplied to a gate of the transistor 131. The strobe signal DQS is supplied to a gate of the transistor 132 via a transfer gate 142.

With the configuration shown in FIG. 7, when the reset signal /RST is at a low level, the source transistor 131 is turned off. Therefore, sub-threshold leakage can be reduced in a non-access state. Meanwhile, when the reset signal /RST is at a high level, the internal write data IDQ0 can be fetched in the latch circuit 80-1 synchronously with the rising edge of the strobe signal DQS. In this case, there is no difference in the signal propagation time of the inverter 120 between a case where the internal write data IDQ0 changes from the high level to the low level and a case where the internal write data IDQ0 changes from the low level to the high level.

It is apparent that the present invention i is not limited to the above embodiments, but may be modified and changed without departing from the scope and spirit of the invention.

For example, the above embodiment has explained an example in which the logical circuit included in the signal transmission circuit is an inverter; however, the present invention is not limited thereto, and other types of logical circuits such as a NAND circuit or a NOR circuit can be also used.

What is claimed is:

1. A semiconductor device comprising:
first and second power supply lines;
a first logical circuit including a first transistor of a first conductive type and a second transistor of a second conductive type, the first and second transistors being connected in series between the first and second power supply lines;
a first source transistor of the first conductive type provided between the first power supply line and the first transistor, the first source transistor being controlled based on a first control signal; and
a first load circuit provided between the second power supply line and the second transistor.

2. The semiconductor device as claimed in claim 1, wherein the first load circuit includes a load transistor of the second conductive type that is fixed to an on state.

3. The semiconductor device as claimed in claim 1, wherein a load amount of the first source transistor in an on state is substantially equal to a load amount of the first load circuit.

4. The semiconductor device as claimed in claim 1, wherein
the first source transistor is turned on when the first control signal is in a first logical level, thereby the first logical circuit generates an output signal according to a logical level of an input signal, and
the first source transistor is turned off when the first control signal is in a second logical level, thereby the output signal from the first logical circuit is fixed to a predetermined logical level.

5. The semiconductor device as claimed in claim 1, further comprising:
a second logical circuit to which an output signal from the first logical circuit is supplied, and that includes a third transistor of the first conductive type and a fourth transistor of the second conductive type, the third and fourth transistors being connected in series between the first and second power supply lines;
a second load circuit provided between the first power supply line and the third transistor; and
a second source transistor provided between the second power supply line and the fourth transistor, the second source transistor being controlled based on a second control signal.

6. The semiconductor device as claimed in claim 5, wherein the first control signal and the second control signal are complementary to each other.

7. The semiconductor device as claimed in claim wherein a load amount of the first load circuit is substantially equal to a load amount of the second source transistor in an on state.

8. The semiconductor device as claimed in claim 7, wherein the first load circuit and the second source transistor have the first conductive type and substantially identical in characteristics.

9. The semiconductor device as claimed in claim 5, wherein a lead amount of the second load circuit is substantially equal to a load amount of the first source transistor in an on state.

10. The semiconductor device as claimed in claim 9, wherein the second load circuit and the first source transistor have the second conductive type and substantially identical in characteristics.

11. The semiconductor device as claimed in claim 1, further comprising a flip-flop circuit to which an output signal from the first logical circuit is supplied.

12. A semiconductor device comprising:
a logical circuit to which an input signal is supplied, a logical level of the input signal changing in an active state and being fixed to one of logical levels in a standby state;
a first power supply line that supplies a first operating potential to the logical circuit;
a second power supply line that supplies a second operating potential to the logical circuit;
a source transistor connected between the logical circuit and the first power supply line, the source transistor being turned on in the active state and turned off in the standby state; and
a load transistor connected between the logical circuit and the second power supply line, the load transistor being fixed to an on state in both the active state and the standby state.
